(19) United States
(12) Patent Application Publication
(10) Pub. No.: US 2016/0318111 A1
(43) Pub. Date: Nov. 3, 2016

(54) WELDING STRUCTURE OF VACUUM VALVE AND METHOD AND APPARATUS THEREOF

(71) Applicant: KING LAI HYGIENIC MATERIALS CO., LTD, ZHUBEI CITY (TW)

(72) Inventor: SHUI-PO LEE, ZHUBEI CITY (TW)

(21) Appl. No.: 14/701,181

(22) Filed: Apr. 30, 2015

(51) Int. Cl. B23K 9/02; B23K 37/04

(52) U.S. Cl. CPC B23K 9/02; B23K 37/04

(57) ABSTRACT

A welding structure of vacuum valve includes a first plate, a second plate, and a cover plate. The second plate has two lateral edges contacting and fixed with two laterals edges of the first plate by internal welding, such that an internal weld bead is formed at the inner edges of the second plate and the first plate contacting each other, respectively. The cover plate is welded to one end of the first plate and one end of the second plate. With the internal welding, the valve body of a vacuum valve is fully welded, so as to prevent the structure of the valve body from being damaged, achieving an actual vacuum environment.

### BACKGROUND OF THE INVENTION

1. Field of the Invention:

The present invention relates to welding structure of vacuum valve and method and apparatus thereof, and more particularly, to an internally welding method for fully and internally welding an object without usage of solder, so as to produce a valve body of a vacuum valve.

2. Description of the Related Art:

Nowadays, most vacuum valve is in a hollowed, flat, and long shape, such that internal welding thereof is uneasy to be practiced. As a result, internal welding is substituted by external welding for facilitating the welding convenience.

Usually, the valve body is welded by externally penetration welding, wherein solder penetrates into the gap of the valve body during the welding process, thereby fully filling the gap in order to seal the valve body, achieving an actual vacuumed environment in the valve body.

However, technical skill of each welding matters during the external welding process. Also, in the penetration welding, two connecting parts of the valve body are liquated, and the solder is subsequently filled therein. During such process, connecting parts of the valve body slightly deform, so as to damage the structure of the valve body, while tiny gaps possibly appear. Once tiny gaps appear, the valve body is prevented from having an actual vacuum status, and service life of the product is thereby shortened.

### SUMMARY OF THE INVENTION

For improving the aforementioned issues, the present invention discloses a welding structure of vacuum valve and method and apparatus thereof, wherein the internal welding process prevents the valve structure from the damaged, such that the actual vacuum status of the valve body is realized.

For achieving the aforementioned objectives, the present invention provides a welding structure of vacuum valve, comprising:
a first plate;
a second plate, having two lateral edges contacting and fixed with two laterals edges of the first plate by internal welding, such that an internal weld bead is formed at the inner edges of the second plate and the first plate contacting each other, respectively; and
a cover plate, welded to one end of the first plate and one end of the second plate.

For achieving the aforementioned objectives, the present invention further provides a welding method of vacuum valve, comprising following steps:
a) providing a first plate and a second plate, and welding a cover plate between one end of the first plate and one end of the second plate to form a hollow object to be welded;
b) placing the object to be welded on a moving seat, which reciprocates against a welding gun; and
c) moving the moving seat toward the welding gun, such that the welding gun is inserted into the object to be welded, so as to weld the first plate and the second plate along two contacting edges thereof, whereby an internal weld bead is formed on two sides within the object to be welded, respectively, and the object to be welded is thereby welded into a valve body of a vacuum valve.

For achieving the aforementioned objectives, the present invention further provides a welding apparatus of vacuum valve, comprising:
a platform;
an electric welding unit, disposed above the platform and provided with a welding gun;
a moving seat, slidingly disposed on the platform for holding a hollow object to be welded; and
a driving unit, for driving the moving seat to reciprocate against the welding gun, such that the welding gun is allowed to be inserted into the hollow object to be welded for internally welding.

Therefore, the present invention enables the hollow object to be welded to be internally welded during the movement, so as to realize an actual vacuum environment of a valve body of a vacuum valve. Also, the welding process of the present invention does not apply solder, so the depth of the internal weld bead is smaller than the depth of the contacting edges of the object to be welded, such that the valve body is prevented from being deformed to damage the structural strength thereof, achieving an actual vacuum environment of the valve body.

Furthermore, for improving the structural strength and the service life of the valve body of the vacuum valve, plural welding structures with intervals therebewtten are able to be applied at the outer edge of each two contacting edges, so as to form a plurality of external weld beads, wherein the length of each external weld bead is shorter than the length of the internal weld bead.

### BRIEF DESCRIPTION OF THE DRAWINGS

FIG. 1 is a perspective view of the welding apparatus in accordance with the present invention.

FIG. 2 is a top view of the welding apparatus in accordance with the present invention.

FIG. 3 is a perspective view of the welding apparatus in accordance with the present invention with an object to be welded placed on the moving seat thereof.

FIG. 4 is an exploded view of the object to be welded.

FIG. 5 is a perspective view of the object to be welded.

FIG. 6 is a schematic view illustrating the welding gun of the present invention inserted into an object to weld therein.

FIG. 7 is a schematic view illustrating the internal welding process, wherein an internal weld bead is formed between the first plate and the second plate.

FIG. 8 is a schematic view illustrating the structures of the internal weld bead and external weld bead of the valve body in accordance with the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

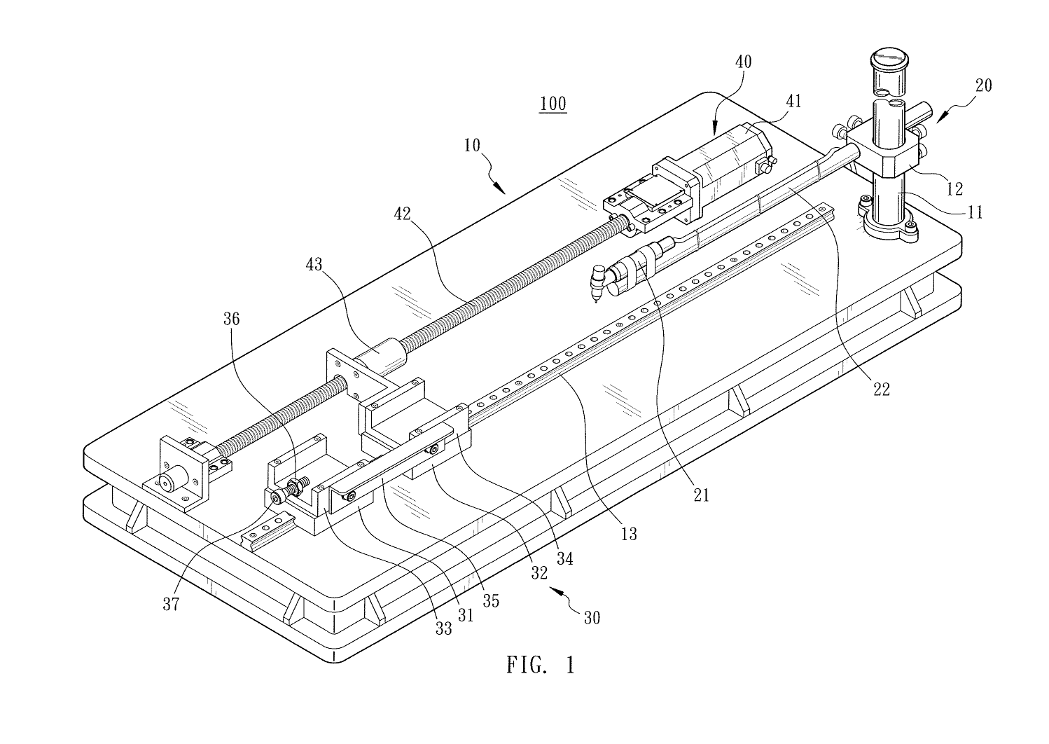

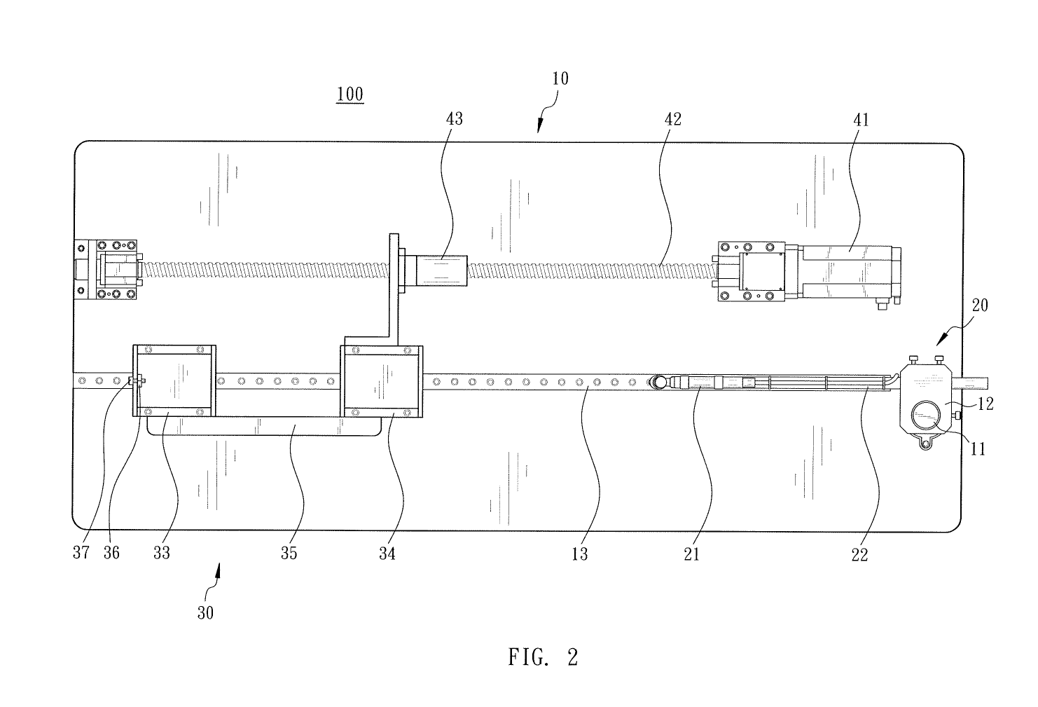

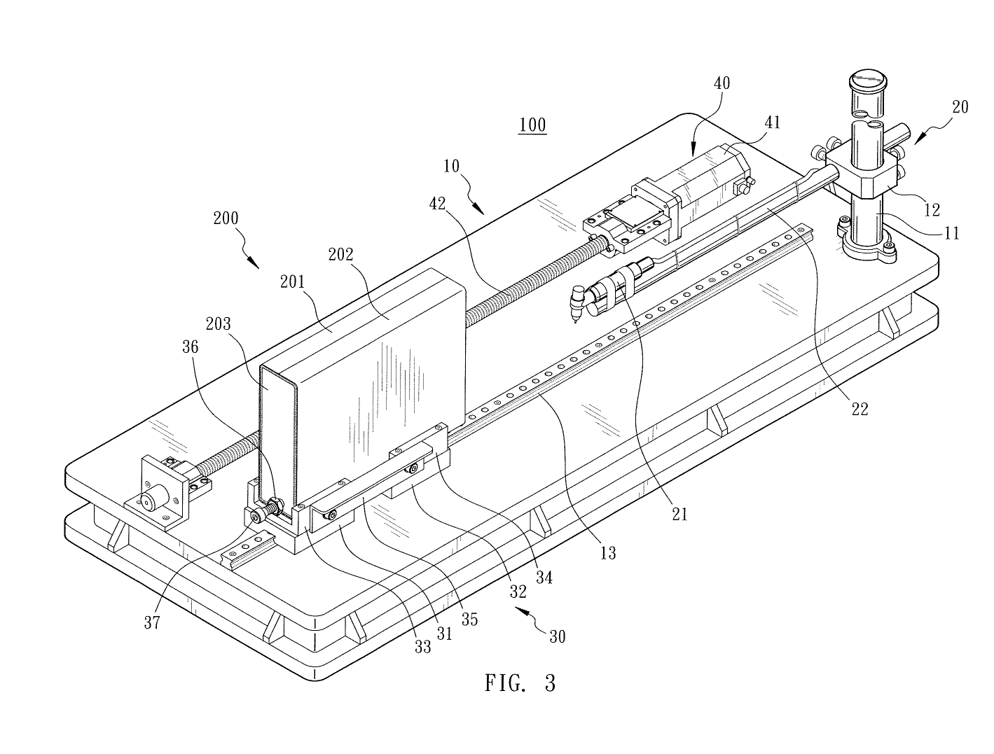

Referring to FIG. 1 to FIG. 8, the welding apparatus of the present provided by the present invention comprises a platform 10, an electric welding unit 20, a moving seat 30, and a driving unit 40.

The platform 10 is in a rectangular shape and has a pole 11 disposed on one corner thereof. A fixing seat 12 is mounted on the pole 11, while the fixing seat 12 is allowed to be mounted by use of screw assemblies, such that position of the fixing seat 12 is axially adjustable along the pole 11.

The electric welding unit 20 is provided with a welding gun 21 and a rod 22. One end of the rod 22 is fixedly combined to the fixing seat 12, with the other end thereof fixed with the welding gun 21, such that the welding gun 21 is suspended upon the platform 10 and vertical against the pole 11. With the adjustment of the fixing seat 12, height of the welding gun 21 is adjusted to facilitate welding processes at different heights.

A rail 13 is disposed on the surface of the platform 10 and parallel positioned against the welding gun 21 under the welding gun 21.

The moving seat 30 is slidingly disposed on the rail 13. Preferably, the moving seat 30 comprises a first sliding block 31 and a second sliding block 32, wherein the first sliding block 31 and the second sliding block 32 are slidingly disposed on the rail 13 with an interval therebetween. The moving seat 30 is further provided with two positioning blocks 33, 34, which are screwedly disposed on top of the first sliding block 31 and the second sliding block 32, respectively, with a binding plate 35 fastened between the two positioning blocks 33, 34. Moreover, the two positioning blocks 33, 34 are in a U shape for receiving a hollow object to be welded 200.

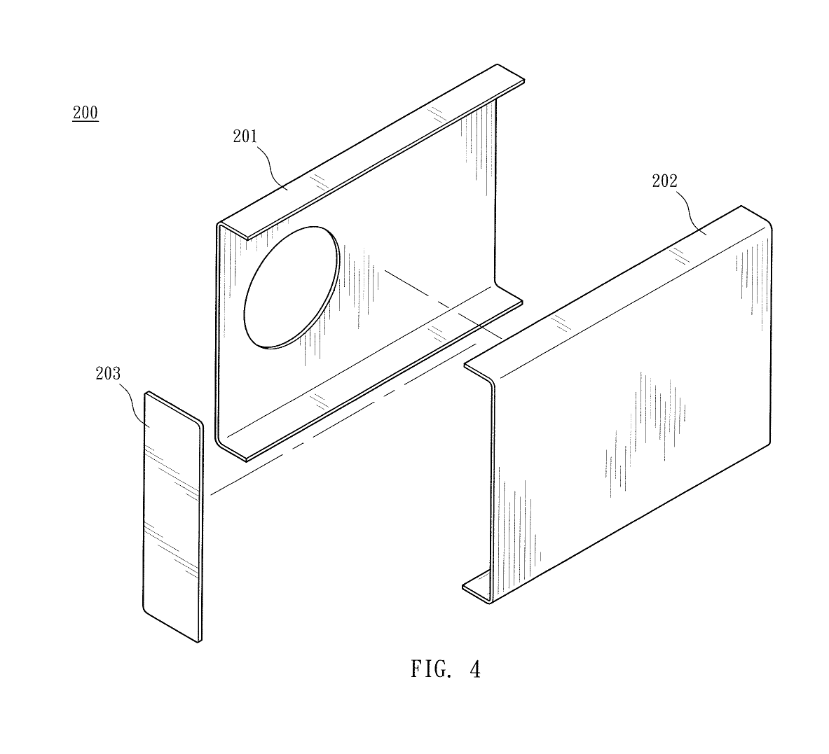

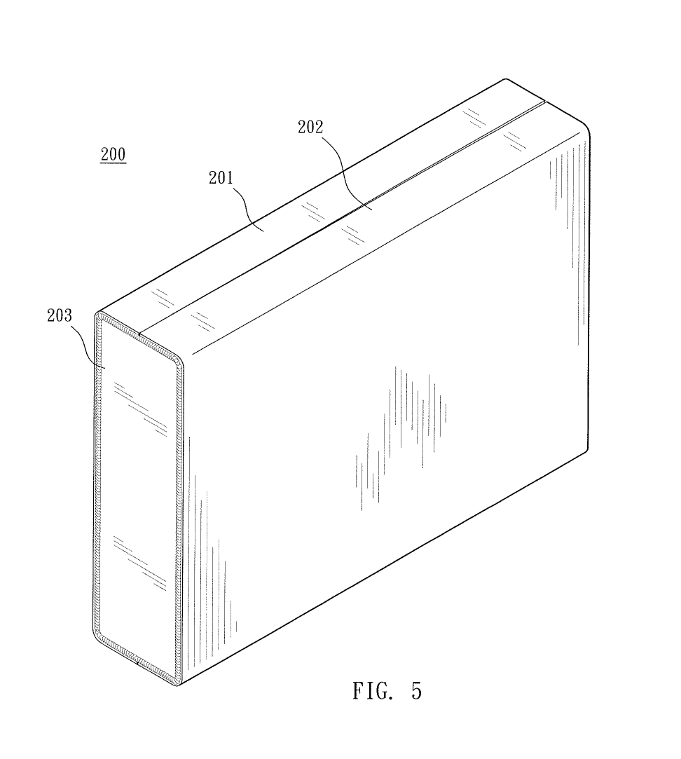

Referring to FIG. 4 and FIG. 5, the object to be welded 200 is hollow and formed of a first plate 201, a second plate 202, which are both in a U shape, and a cover plate 203 welded to one end of the first plate 201 and the second plate 202 in advance, wherein the first plate 201 and the second plate 202 are combined to each other to form a hollow and flat shape, so as to assure a solid structure thereof and facilitate the welding process afterward. The object to be welded 200 is subsequently placed on the moving seat 30.

The positioning block 33 on one end of the moving seat 30 away from the welding gun 21 has a front edge provided with a nut 36 and a position limiting screw 37 screwed to the nut 36, such that when the object to be welded 200 is placed on the moving seat 30, a front edge of the object to be welded 200 is stopped to prevent the object to be welded 200 from moving away from the welding gun 21 during the welding process.

The driving unit 40 drives the moving seat 30 to reciprocate against the welding gun 21, such that the welding gun 21 is allowed to be inserted into the object to be welded 200 to weld therein. The driving unit 40 comprises a motor 41, a thread rod 42, and a combining member 43. The motor 41 is installed on the platform 10 and positioned on one side of the electric welding unit 20. The thread rod 42 is coupled with the motor 41 and thus rotates with the motor 41. The thread rod 42 is on a lateral side of the rail 13 and parallel against the rail 13, while the combining member 43 is screwedly mounted around the thread rod 42 and connected to the moving seat 30. Preferably, the combining member 43 is combined to the positioning block 34 which is closer to the welding gun 21 than the positioning block 33. As a result, when the motor 41 drives the thread rod 42 to rotate, the combining member 43 triggers the moving seat 30 to reciprocate on the rail 13 toward or away from the welding gun 21, facilitating the welding operation.

Especially, the moving speed of the moving seat 30 of the present invention is relatively slow at a speed ratio of 15-22 mm/min, so that no specific clamping structure is provided to the moving seat 30. Size of the positioning blocks 33, 34 shall correspondingly match the size of the object to be welded 200. Regarding other objects to be welded 200 with different sizes, the positioning blocks 33, 34 are screwedly combined to the first sliding block 31 and the second sliding block 32, such that positioning blocks 33, 34 with different sizes are allowed to be optionally received on the first and second sliding blocks 31, 32 for holding other objects to be welded 200 with different sizes. Also, the distance between the first sliding block 31 and the second sliding block 32 is determined by the length of the object to be welded 200. When the length of the object to be welded 200 is relatively longer, a binding plate 35 having a longer length is applied, so as to lengthen the distance between the first and second sliding blocks 31, 32, whereby the object to be welded 200 is stably placed on the moving seat 30.

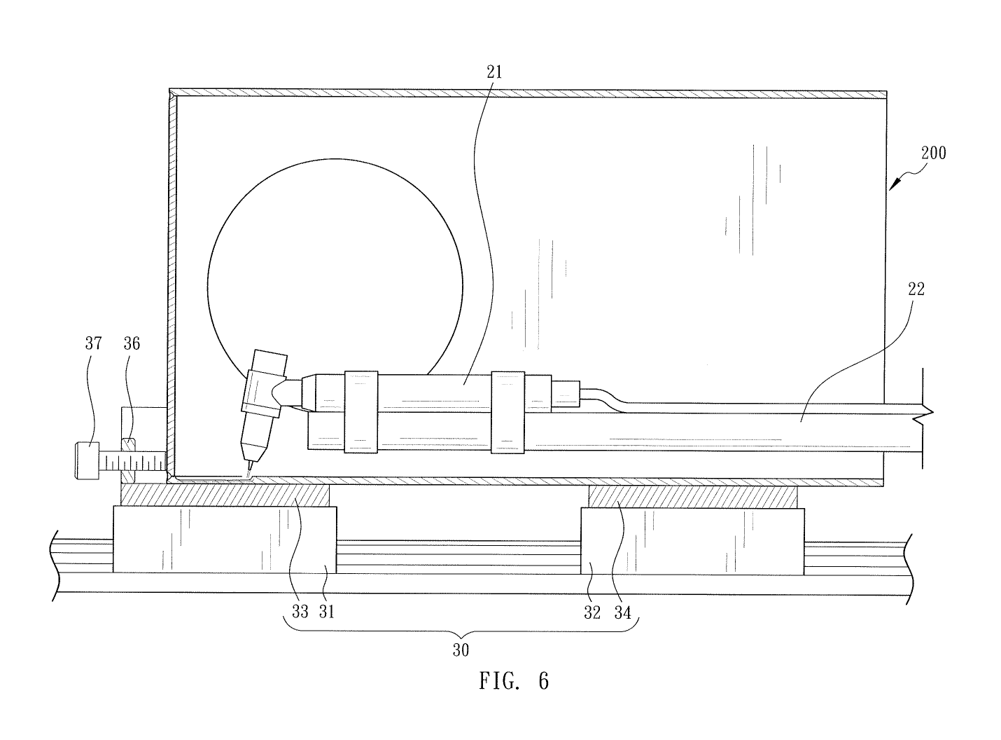

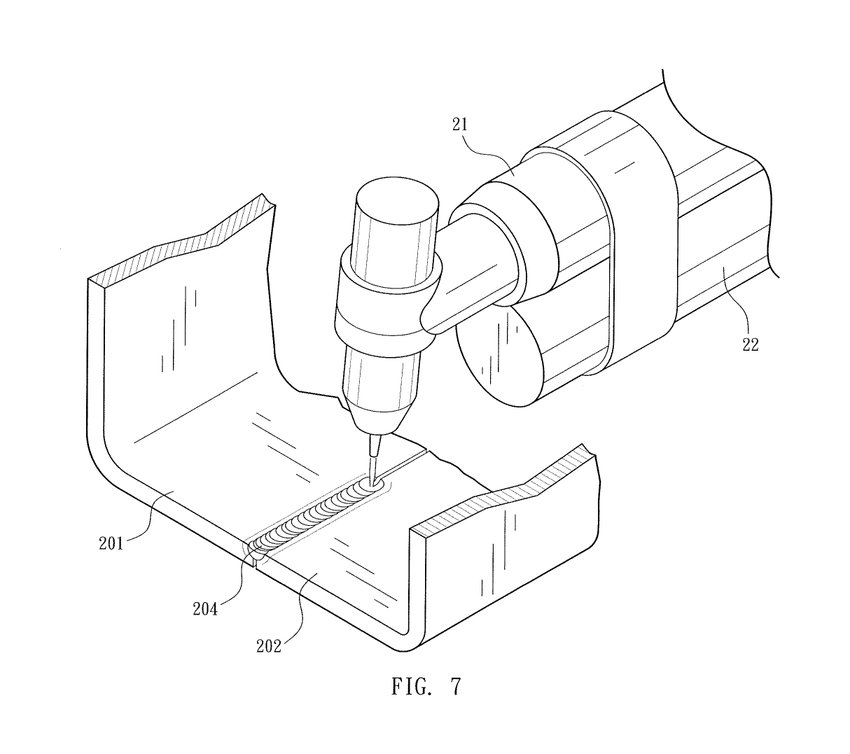

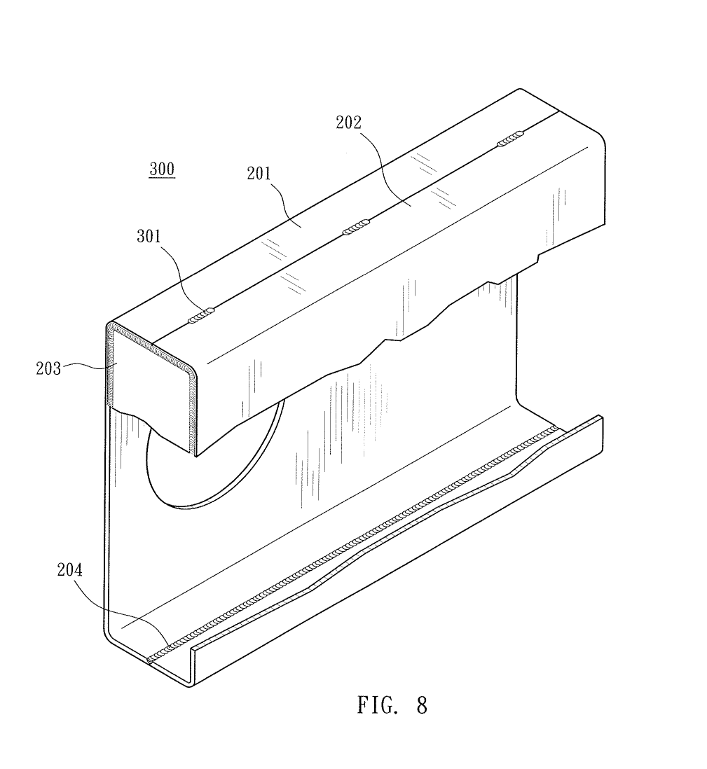

FIG. 6 and FIG. 7 are schematic views illustrating the welding operation carried out in accordance with the present invention. First, height of the welding gun 21 is adjusted in advance, so that the moving seat 30 is allowed to carry the object to be welded 200 toward the welding gun 21, whereby the welding gun 21 is inserted into the object to be welded 200, so as to internally weld each two contacting edges in a manner of self-fusible welding. Preferably, an internal weld bead 204 is formed on two sides within the object to be welded 200, whereby the object to be welded 200 is welded into a valve body 300 of a vacuum valve, as shown in FIG. 8.

Due to the fact that no solder is applied in the welding process provided by the present invention, an actual vacuum environment is achieved in the valve body; also, depth of the internal weld bead 204 is smaller than the depth of the contacting edges of the object to be welded 200, so as to prevent the valve body 300 from deforming to damage the structural strength thereof. In addition, because the depth of the internal weld bead 204 is relatively small, gaps are prevented from occurring thereupon, further preventing dirt from accumulating in the gaps.

In addition, as shown in FIG. 8, plural welding structures with intervals therebetween are allowed to be cast at the outer edge of each two contacting edges of the valve body 300, whereby plural external weld beads 301 are formed thereon, wherein length of the external weld bead 301 is smaller than the length of the internal weld bead 204, such that the overall structural strength is enhanced, and the service life of the product is lengthened.

More particularly, the external weld bead 301 is formed of plural welding structures with intervals therebetween. When the valve body 300 is tested by use of nitrogen detector, the nitrogen is easier to enter the inner space of the valve body 300, whereby gas leakage thereof is easier to be detected for further welding patching repair. If the external weld bead 301 is cast in a manner of full welding, the contacting edges are usually filled up by the weld beads on the both sides, such that gas leakage thereof is uneasy to be detected by use of the nitrogen detector.

The welding method of the valve body 300 in accordance with the present invention comprises following steps:
a) providing a first plate 201 and a second plate 202 which are both in a U shape, and welding a cover plate 203 between one end of the first plate 201 and one end of the second plate 202 to form a hollow object to be welded 200;
b) placing the object to be welded 200 on a moving seat 30 on the platform 10; and
c) moving the moving seat 30 toward the welding gun 21, such that the welding gun 21 is inserted into the object to be welded 200, so as to weld the first plate 201 and the second plate 202 along two contacting edges thereof, whereby an internal weld bead 204 is formed on two sides within the object to be welded 200, respectively, and the object to be welded 200 is thereby welded into a valve body 300 of a vacuum valve.

With such welding method, the valve body 300 is internally fully welded, whereby the structure is prevented from being damaged, and the structural strength and service life of the valve body 300 are improved. In addition, the welding structure at the outer edge of the first plate 201 and the second plate 202 is formed of plural external weld beads 301 with an intervals between each two external weld beads 301.

The welding structure of the valve body 300 provided by the present invention is accomplished by use of the aforementioned apparatus and method, wherein the first plate 201 and the second plate 202 are correspondingly combined and fixed by internal welding, whereby the internal weld bead 204 is formed on the inner side of each two contacting edges, and the cover plate 203 is welded and fixed on one end of the first plate 201 and one end of the second plate 202.

Further, the welding structure at the outer edge of each two contacting ends of the first and second plates 201, 202 is formed of plural external weld beads 301, thereby enhancing the structural strength of the valve body 300.

With the welding method provided by the present invention, the welding gun 21 is fixed, and the object to be welded 200 moves toward the welding gun 21 to be internally welded without solder, such that the welding operation within the narrow and hollow valve body 300 is allowed to be cast, thereby achieving an actual vacuum environment in the valve body 300. Also, through the internal welding process, the valve body 300 is prevented from deforming to damage the structural strength thereof. Further, the outer edge of the valve body 300 is externally welded with plural intervals between the external weld beads 301, the overall structural strength is enhanced, and the service life of the product is improved.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A welding structure of vacuum valve, comprising:
a first plate;
a second plate, having two lateral edges contacting and fixed with two laterals edges of the first plate by internal welding, such that an internal weld bead is formed at the inner edges of the second plate and the first plate contacting each other, respectively; and
a cover plate, welded to one end of the first plate and one end of the second plate.

2. The welding structure of claim 1, wherein the first plate and the second plate are both in a U shape.

3. The welding structure of claim 1, wherein an outer edge of the first plate and an outer edge of the second plate contacting each other are welded to form plural external weld beads with an interval between each two external weld beads.

4. A welding method of vacuum valve, comprising following steps:
a) providing a first plate and a second plate, and welding a cover plate between one end of the first plate and one end of the second plate to form a hollow object to be welded;
b) placing the object to be welded on a moving seat which reciprocates against a welding gun; and
c) moving the moving seat toward the welding gun, such that the welding gun is inserted into the object to be welded, so as to weld the first plate and the second plate along two contacting edges of the first plate and the second plate, whereby an internal weld bead is formed on two sides within the object to be welded, respectively, and the object to be welded is thereby welded into a valve body of a vacuum valve.

5. The welding method of claim 4, wherein, after the internal welding step in step c), outer edge of the first plate contacting the second plate is welded to form plural external weld beads with an interval between each two external weld beads.

6. The welding method of claim 5, wherein the length of each external weld bead is smaller than the length of each internal weld bead.

7. The welding method of claim 5, wherein the first plate and the second plate are both in a U shape.

8. A welding apparatus, comprising:
a platform;
an electric welding unit, disposed above the platform and provided with a welding gun;
a moving seat, slidingly disposed on the platform for the an object to be welded to be placed thereon; and
a driving unit, for driving the moving seat to reciprocate against the welding gun, such that the welding gun is allowed to be inserted into the object to be welded for internally welding.

9. The welding apparatus of claim 8, wherein the platform is provided with a pole having a fixing seat, and a rod is formed on the fixing seat, while the welding gun is fixedly combined to one end of the rod.

10. The welding apparatus of claim 9, wherein height of the fixing seat is allowed to be axially adjusted along the pole.

11. The welding apparatus of claim 8, wherein the platform is provided with a rail for the moving seat to be slidingly disposed on the rail.

12. The welding apparatus of claim 8, wherein the driving unit has a motor disposed on the platform, a thread rod combined to the motor and thus rotates with the motor, and a combining member disposed between the moving seat and the thread rod, such that the motor drives the combining member to axially move along the thread rod, so as to triggers the moving seat to reciprocate.

13. The welding apparatus of claim 11, wherein the moving seat comprises a first sliding block and a second sliding block slidingly disposed on the rail with an interval between the first sliding block and the second sliding block, while two positioning blocks are disposed on the first sliding block and the second sliding block, respectively, and a binding plate is fastened between the two positioning blocks, wherein the two positioning blocks are both in a U shape for receiving the object to be welded.

14. The welding apparatus of claim 13, wherein the positioning block of the two positioning blocks has a front edge provided with a nut and a position limiting screw which is screwed to the nut for stopping against a front edge of the object to be welded.

15. The welding apparatus of claim 13, wherein the two positioning blocks are screwed to the first sliding block and the second sliding block, respectively.

16. The welding apparatus of claim 8, wherein the object to be welded is formed of a first plate and a second plate which are both in a U shape.
